(19) United States
(12) Patent Application Publication
(10) Pub. No.: US 2013/0111231 A1
(43) Pub. Date: May 2, 2013

(54) CONTROL CIRCUIT FOR POWER SUPPLY OF MEMORY

(71) Applicants: YUAN-XI CHEN, Shenzhen City (CN); YING-BIN FU, Shenzhen City (CN)

(72) Inventors: YUAN-XI CHEN, Shenzhen City (CN); YING-BIN FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/557,324

(22) Filed: Jul. 25, 2012

(30) Foreign Application Priority Data
Oct. 28, 2011 (CN) 201110333557.3

(51) Int. Cl. G06F 1/26

(52) U.S. Cl. 713/300

(57) ABSTRACT

A control circuit for a power supply of a memory includes a power controller, a keyboard, and a processing circuit. The power controller is connected to the power supply. The keyboard sets working mode of the power supply and a voltage output from the power supply. The processing circuit is connected to the power controller and the keyboard. The processing circuit processes instructions input from the keyboard such that the working mode of the power supply and the voltage output from the power supply can be set through the keyboard.

### BACKGROUND

1. Technical Field

The present disclosure relates to a circuit for controlling a power supply of a memory.

2. Description of Related Art

In some CPU platforms, a power supply for memories can work in three modes. The CPU adjusts the working mode of the power supply according to the number of memories plugged into memory slots connected to the CPU, and adjusts voltage output from the power supply according to specifications of the memory slots. However, the power supply further supplies power for the CPU, and the CPU is sensitive and can easily be damaged if it receives the wrong output from the power supply.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a control circuit for a power supply of a memory.

FIG. 2 is a circuit diagram of the control circuit of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

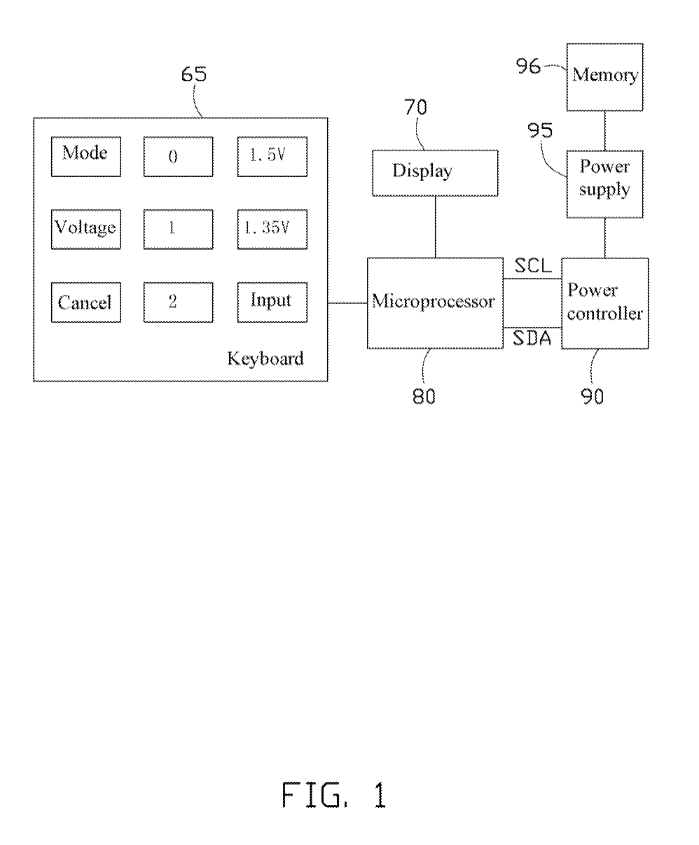

Referring to FIG. 1, a control circuit is used for controlling working status of a power supply 95 for a memory 96, and voltage output from the power supply 95. An exemplary embodiment of the control circuit includes a keyboard 65, a processing circuit 80 connected to the keyboard 65, a display 70 connected to the processing circuit 80, and a power controller 90 connected between the processing circuit 80 and the power supply 95.

The keyboard 65 includes a “Mode” button, a “Voltage” button, a “Cancel” button, and an “Input” button. When the “Mode” button is pressed, a menu of working modes of the power supply 95 is displayed by the display 70. The menu of working modes includes a first mode, a second mode, and a third mode. The keyboard 65 further includes a “0” button, a “1” button, and a “2” button. When the “0” button is pressed, the first mode is selected. When the “1” button is pressed, the second mode is selected. When the “2” button is pressed, the third mode is selected.

The “Voltage” button is used to set the voltage output from the power supply 95. In the embodiment, the power supply 95 outputs 1.5 volts or 1.35 volts. The keyboard 65 further includes a “1.5V” button and a “1.35V” button. Once the “Voltage” button has been pressed, the “1.5V” button can be pressed and the power supply 65 outputs the 1.5 volts, or the “1.35V” button can be pressed and the power supply 65 outputs the 1.35 volts.

The display 70 also displays the working mode of the power supply 95 and the voltage output by the power supply 95.

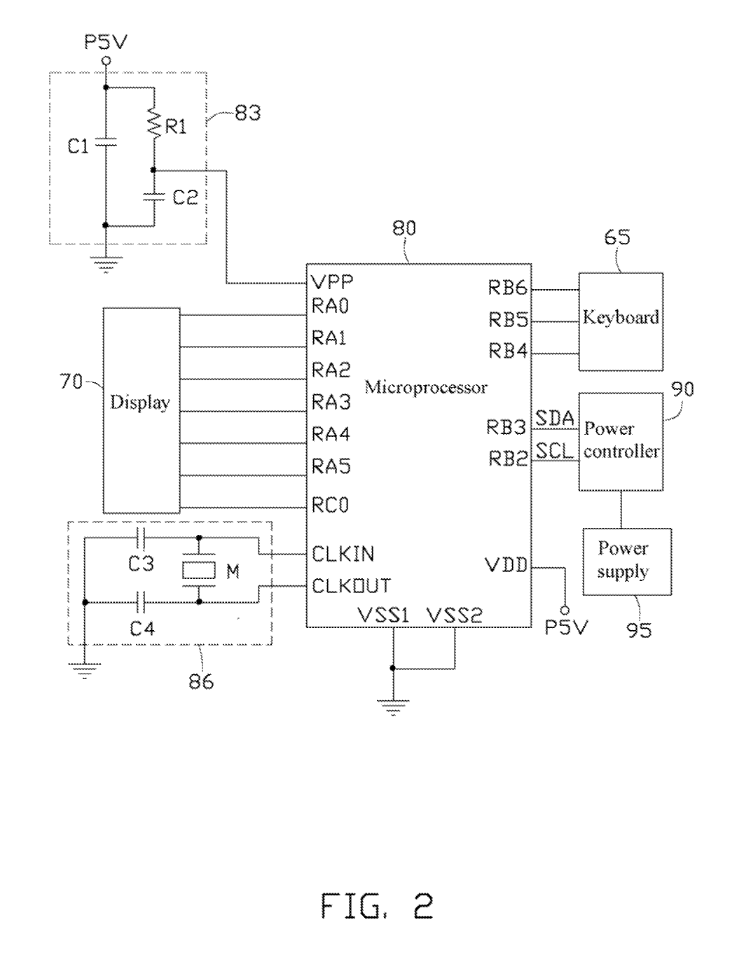

Referring to FIG. 2, the processing circuit 80 includes a microprocessor U1, a filtering circuit 83, and a clock generating circuit 86. The filtering circuit 83 includes two capacitors C1 and C2, and a resistor R1. The clock generating circuit 86 includes two capacitors C3 and C4, and a crystal oscillator M.

A direct current (DC) power P5V is grounded through the capacitor C1. The DC power P5V is further grounded through the resistor R1 and the capacitor C2 connected in series. A node between the resistor R1 and the capacitor C2 is connected to a positive power pin VPP of the microprocessor U1. Two terminals of the crystal oscillator M are grounded respectively through the capacitors C3 and C4. The terminals of the crystal oscillator M are further connected to clock pins CLKIN and CLKOUT of the microprocessor U1, respectively. Output pins RA0-RA5 and RC0 of the microprocessor U1 are connected to the display 70. Negative power pins VSS1 and VSS2 of the microprocessor U1 are grounded. A positive power pin VDD of the microprocessor U1 is connected to the DC power PSV. Input pins RB4-RB6 of the microprocessor U1 are connected to the keyboard 65. Output pins RB2 and RB3 of the microprocessor U1 are respectively connected to a clock pin SCL and a data pin SDA of the power controller 90 through the system management bus (SMBUS).

To set the working mode of the power supply 95, the “Mode” button of the keyboard 65 is pressed. The display 70 displays the first mode, the second mode, and the third mode. In this condition, any one of the “0” button, the “1” button, or the “2” button can be pressed to select the working mode of the power supply 95. For example, when the “0” button is pressed, the display 70 displays that the power supply 95 will work in the first mode. If the working mode of the power supply 95 needs to be changed, the “Cancel” button is pressed, and the working mode of the power supply 95 can be selected again. After the “0” button is pressed, the “Input” button is pressed, and the display 70 displays that the power supply 90 is working in the first mode. Meanwhile, the microprocessor U1 writes parameters of the first mode into a corresponding register of the power controller 90 through the SMBUS. As a result, the power controller 90 controls the power supply 95 to work in the first mode.

To set the voltage output from the power supply 95, the “Voltage” button of the keyboard 65 is pressed. The display 70 displays “1.5V” and “1.35V”. In this condition, the “1.5V” button or the “1.35V” button can be pressed to select the voltage output from the power supply 95. For example, if the “1.35V” button is pressed, the display 70 displays that the power supply 95 will output 1.35 volts. If the voltage output from the power supply 95 needs to be changed, the “Cancel” button is pressed, and the voltage output from the power supply 95 can be selected again. After the “1.35V” button is pressed, the “Input” button is pressed, and the display 70 displays that the power supply 95 is outputting 1.35 volts. Meanwhile, the microprocessor U1 writes parameters corresponding to the 1.35 volts into a corresponding register of the power controller 90 through the SMBUS. As a result, the power controller 90 controls the power supply 95 to output 1.35V.

In the embodiment, the microprocessor U1 processes instructions input from the keyboard 65, such that operators can set the working mode of the power supply 95 and the voltage the power supply 95 outputs using the keyboard 65. As a result, the power supply 95 can be adjusted without a central processing unit.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A control circuit for a power supply of a memory, comprising:
a power controller connected to the power supply;
a keyboard to set working mode of the power supply and a voltage output from the power supply;
a processing circuit connected to the power controller and the keyboard, wherein the processing circuit processes instructions input from the keyboard such that the working mode of the power supply and the voltage output from the power supply can be set through the keyboard.

2. The control circuit of claim 1, further comprising a display connected to the processing circuit, wherein the display displays the working mode of the power supply and the voltage output from the power supply.

3. The control circuit of claim 2, wherein the processing circuit comprises a microprocessor, a filtering circuit, and a clock generating circuit; first to seventh output pins of the microprocessor are connected to the display, first and second negative power pins of the microprocessor are grounded, a first positive power pin of the microprocessor is connected to a direct current power, first to third input pins of the microprocessor are connected to the keyboard, an eighth output pin of the microprocessor is connected to a clock pin of the power controller through a system management bus, a ninth output pin of the microprocessor is connected to a data pin of the power controller through the system management bus; wherein the filtering circuit comprises a first resistor, a first capacitor, and a second capacitor; the direct current power is grounded through the first capacitor, the direct current power is further grounded through the first resistor and the second capacitor connected in series, a node between the first resistor and the second capacitor is connected to a second positive power pin of the microprocessor; wherein the clock generating circuit comprises a crystal oscillator, a third capacitor, and a fourth capacitor, a first terminal of the crystal oscillator is grounded through the third capacitor, a second terminal of the crystal oscillator is grounded through the fourth capacitor; the first and second terminals of the crystal oscillator are respectively connected to first and second clock pins of the microprocessor.

4. The control circuit of claim 1, wherein the keyboard comprises:
a mode button, wherein when the mode button is pressed, a menu of working modes of the power supply is displayed, the menu of working modes includes a first mode, a second mode, and a third mode;
a first mode button, wherein when the first mode button is pressed, the first mode is selected;
a second mode button, wherein when the second mode button is pressed, the second mode is selected;
a third mode button, wherein when the third mode button is pressed, the third mode is selected;
a voltage button, wherein when the voltage button is pressed, a menu of voltages of the power supply is displayed, the menu of voltages comprises 1.5 volts and 1.35 volts;
a first voltage button, wherein when the first voltage button is pressed, the 1.5 volts is selected;
a second voltage button, wherein when the second voltage button is pressed, the 1.35 volts is selected;
a cancel button, wherein when the cancel button is pressed, the selected working mode and the voltage are canceled; and
an input button, when the input button is pressed, the selected working mode and the voltage are activated.
